(19) United States
(12) Patent Application Publication
(10) Pub. No.: US 2026/0061231 A1
(43) Pub. Date: Mar. 5, 2026

(54) SELF-RETRACTING LIFELINE DEVICE

(71) Applicant: CHINHUNG CHEN, Taipei City (TW)

(72) Inventor: CHINHUNG CHEN, Taipei City (TW)

(21) Appl. No.: 19/307,008

(22) Filed: Aug. 21, 2025

(30) Foreign Application Priority Data
Sep. 3, 2024 (TW) 113133280

(51) Int. Cl. A62B 35/00

(52) U.S. Cl. CPC A62B 35/0093

(57) ABSTRACT

A self-retracting lifeline device includes a securing frame, cable drum, a centrifugal ratchet mechanism and a housing. The securing frame has a cavity, downward extending first and second flanges, and first and second shafts. This cable drum is rotatably mounted on the first shaft. A cable wound on the cable drum. The centrifugal ratchet mechanism is rotatably mounted on the second shaft and has a second gear gearing with a first gear. This housing accommodates the securing frame, the cable drum, and the centrifugal ratchet mechanism. When the rotational speed of the centrifugal ratchet mechanism is higher than a predetermined speed, a centrifugal force will cause the cable drum to be locked immediately so that the falling of the cable will be stopped.

### FIELD OF THE INVENTION

The invention relates to improved self-retracting lifeline devices and more particularly to an improved self-retracting lifeline device having the advantages of being appropriate for a longer cable and being more sensitive to arrest the falling cable when the improved self-retracting lifeline device is braked.

### BACKGROUND OF THE INVENTION

A conventional self-retracting lifeline device (not shown) comprises a housing having an opening for a cable, a cable drum (not shown) rotatably mounted within the housing, a cable wound on the cable drum, and a central ratchet mechanism (not shown) mounted within the housing. When the cable is pulled down suddenly, the cable drum rotates so as to coaxially rotate the central ratchet mechanism simultaneously. After the cable has been pulled down a sufficient length, the central ratchet mechanism will be braked (and locked) due to centrifugal force. As a result, a person secured to the cable will be prevented from falling. The following two scenarios are assumed.

Usually, the length of the cable can be divided into different sizes, such as 8 meters, 15 meters, 30 meters (or other specifications).

For example, after the 8-meter cable has been wound on the cable drum, the diameter of the whole wound cable is about 10 cm.

After the 30-meter cable has been wound on the cable drum, the diameter of the whole wound cable is about 30 cm.

Now, the above two cables are tested at the same time. It is understood that tangential speed is angular velocity times radius. Therefore, when the same object (having same weight) is hung by one of the cables and falls (i.e., the same tangential speed), the angular velocities of the above two test groups in operation are inversely proportional, i.e., 3:1 with respect to the radius ratio of 10:30 when they are wound on the cable drum. In other words, the angular velocity of the 30-meter cable is lower (i.e., about one third of the angular velocity of the 10-meter cable). Since the angular velocity of the 30-meter cable is lower in operation, it is more difficult to brake the central ratchet mechanism by means of centrifugal force. This adverse situation is more obvious when the diameter of the cable is greater. It may cause difficulties in the design of the central ratchet mechanism.

Thus, the need for improvement still exists.

### SUMMARY OF THE INVENTION

It is therefore one object of the invention to provide an improved self-retracting lifeline device having the advantages of being appropriate for a longer cable and being more sensitive to arrest the falling cable when the improved self-retracting lifeline device is braked. Specifically, the invention aims to solve the problems of the conventional art. It is understood that tangential speed is angular velocity times radius. Thus, when the same object is hung by one of the cables and falls (i.e., the same tangential speed), the angular velocity of the longer cable is lower than that of the shorter cable in operation because the angular velocities of the cables are inversely proportional with respect to their radius ratio when they are wound on the cable drum. It is more difficult to brake the central ratchet mechanism by means of centrifugal force. This adverse situation is more obvious when the diameter of the cable is greater. It may cause difficulties in the design of the central ratchet mechanism.

To achieve above and other objects of the invention, the invention provides an improved self-retracting lifeline device, comprising:
a securing frame including a hanging portion, a top plate, a cavity, a first flange, a second flange, a first shaft, and a second shaft wherein the top plate is secured to the hanging portion, the first flange and the second flange are extended downward from two sides of the top plate respectively, the first shaft is disposed across the first flange and the second flange, and the second shaft is disposed through the second flange and above the first shaft;
a cable drum rotatably mounted on the first shaft and disposed between the first flange and the second flange, a cable wound on the cable drum and unwindable therefrom, the cable drum including opposite first and second discs wherein the first disc includes a first gear facing the second flange, the first gear includes a plurality of inner teeth, and the cable drum has a first rotational speed;
a centrifugal ratchet mechanism rotatably mounted on the second shaft, the centrifugal ratchet mechanism including a second gear and a centrifugal ratchet wherein the second gear and the centrifugal ratchet are formed as a unit, the second gear includes a plurality of outer teeth engaged the inner teeth of the first gear, the centrifugal ratchet includes two opposite ring-shaped surfaces and a plurality of pivoted ratchet portions, and the centrifugal ratchet mechanism has a second rotational speed; and
a housing be secured with the securing frame, the housing including a first shell, a second shell, and a space wherein the first shell and the second shell are configured to assemble and the space is formed between the first shell and the second shell; the housing be provided for accommodating the securing frame, the cable drum, and the centrifugal ratchet mechanism;
wherein in response to the second rotational speed being greater than a predetermined speed in operation, a centrifugal force pushes the pivoted ratchet portions outward over the ring-shaped surfaces and one of the pivoted ratchet portions inserts into the cavity to be locked therein, thereby decreasing the second rotational speed to zero, decreasing the first rotational speed to zero, stopping the cable drum from rotating, and stopping a pulling of the cable; and wherein in response to the second rotational speed being less than the predetermined speed in operation, the cable drum is configured to rotate freely and the cable is configured to unwind from the cable drum.

The above and other objects, features and advantages of the invention will become apparent from the following detailed description taken with the accompanying drawings.

### BRIEF DESCRIPTION OF DRAWINGS

FIG. 1 is an exploded view of an improved self-retracting lifeline device according to the invention;

FIG. 2A is an exploded, partially broken away view of the securing frame in FIG. 1;

FIG. 2B is a perspective view showing a relation of the second gear and the corresponding centrifugal ratchet in FIG. 1;

FIG. 3 is a partially exploded view of the improved self-retracting lifeline device in FIG. 1;

FIG. 4 is a perspective view of the improved self-retracting lifeline device;

FIG. 5 is a front view of the improved self-retracting lifeline device in FIG. 4;

FIG. 6 is a sectional view taken along line VI-VI in FIG. 5;

FIG. 7 is a side elevation view of the improved self-retracting lifeline device in FIG. 4; and

FIG. 8 is a sectional view taken along line VIII-VIII in FIG. 7.

### DETAILED DESCRIPTION OF THE INVENTION

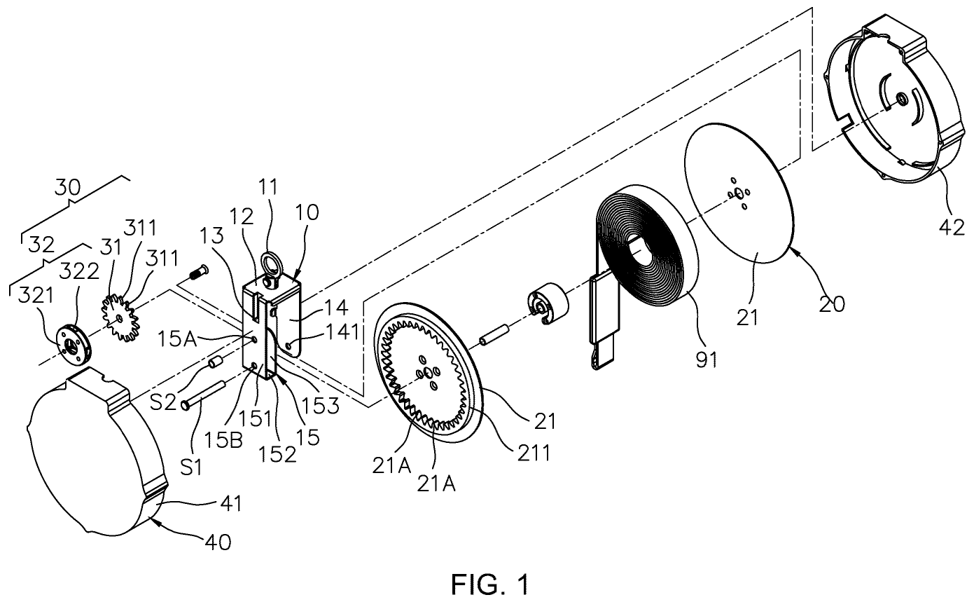

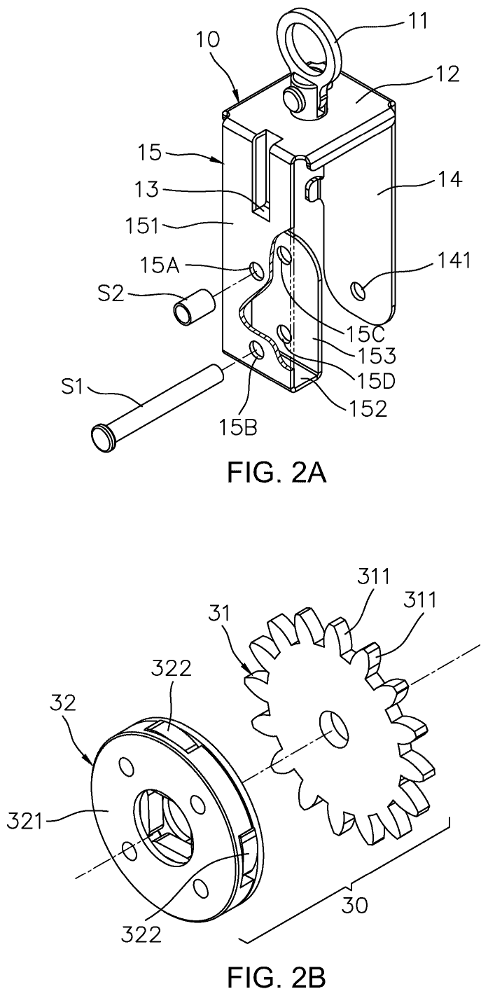

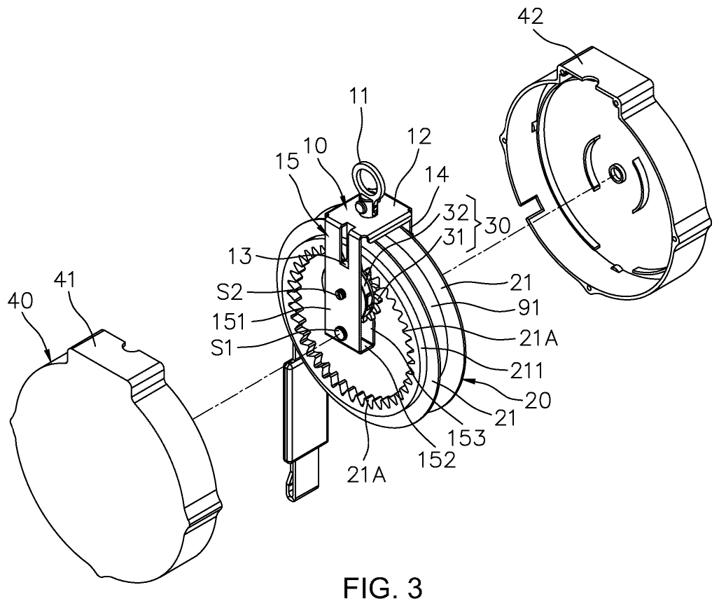

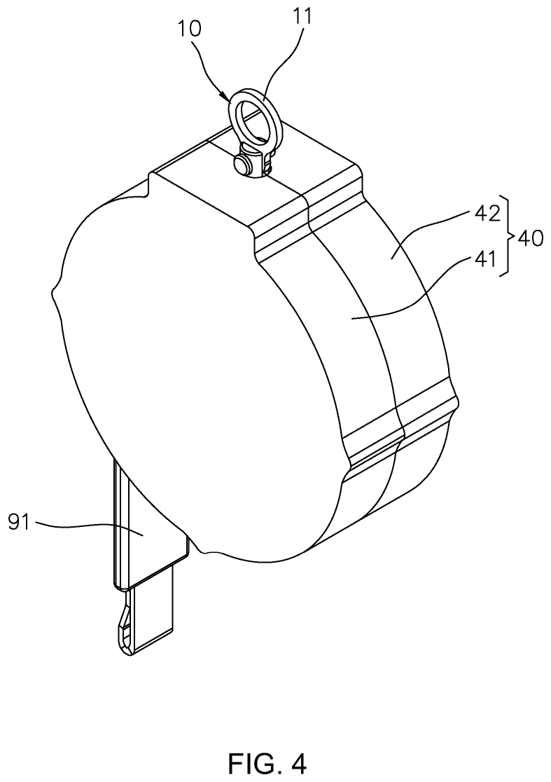

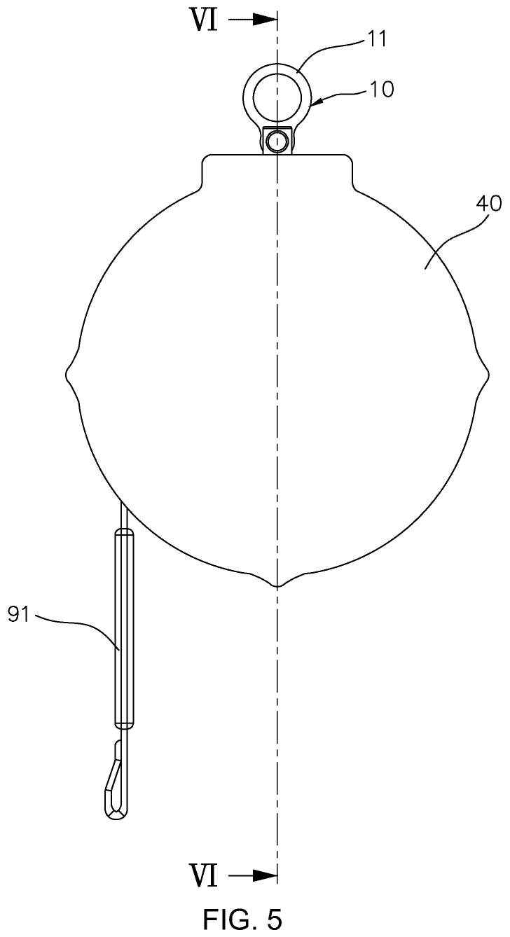

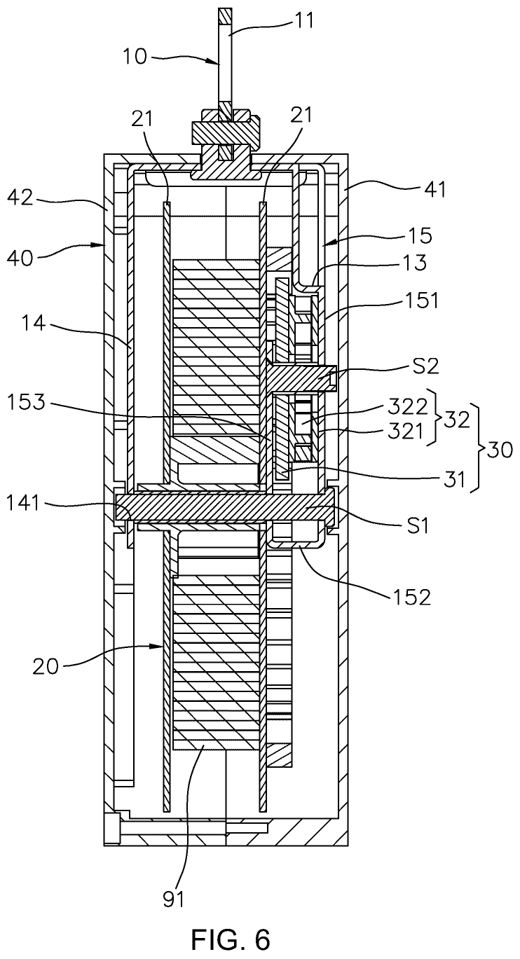

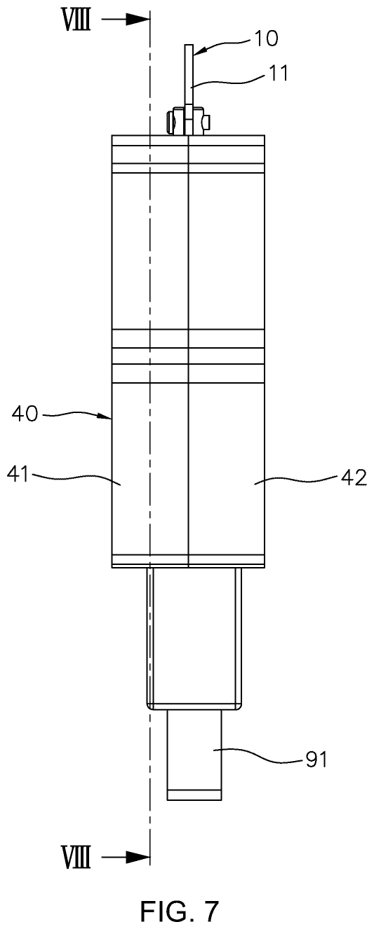

Referring to FIGS. 1 to 8, an improved self-retracting lifeline device in accordance with the invention comprises the following components as discussed in detail below.

A securing frame 10 comprises a hanging portion 11 (forming a ring for hanging), a top plate 12, a cavity 13, a first flange 14, a second flange 15, a first shaft S1, and a second shaft S2. The hanging portion 11 is provided on the top plate 12. The first flange 14 and the second flange 15 are extended downward from two sides of the top plate 12 respectively. The first shaft S1 is provided across the first flange 14 and the second flange 15. The second shaft S2 is provided through the second flange 15 and above the first shaft S1.

A cable drum 20 is rotatably mounted on the first shaft S1 and disposed between the first flange 14 and the second flange 15. A cable 91 is wound on the cable drum 20 and unwindable therefrom. The cable drum 20 includes two opposite discs 21. One of the discs 21 includes a first gear 211 provided on an outer surface facing the second flange 15. The first gear 211 includes a plurality of inner teeth 21A. A rotational speed of the cable drum 20 is defined as a first rotational speed.

A centrifugal ratchet mechanism 30 is rotatably mounted on the second shaft S2. The centrifugal ratchet mechanism 30 comprises a second gear 31 and a centrifugal ratchet 32. The second gear 31 and the centrifugal ratchet 32 are formed (or connected) as an integral structure. The second gear 31 includes a plurality of outer teeth 311 that is engaged with the inner teeth 21A. The centrifugal ratchet 32 includes two opposite ring-shaped surfaces 321 and a plurality of pivoted ratchet portions 322. Another rotational speed of the centrifugal ratchet mechanism 30 is defined as a second rotational speed.

A housing 40 is secured with the securing frame 10. The housing 40 includes a first shell 41, a second shell 42, and a space 43. The first shell 41 and the second shell 42 can be assembled and the space 43 is formed between them. The housing 40 is provided for accommodating the securing frame 10, the cable drum 20 and the centrifugal ratchet mechanism 30.

In response to the second rotational speed being greater than a predetermined speed in operation, the centrifugal force pushes the pivoted ratchet portions 322 moving outward over the ring-shaped surfaces 321, and at least one of the pivoted ratchet portions 322 inserts into the cavity 13 to be locked therein (such as locked by an edge of the cavity 13). It is noted the ratchet is well known in the art and thus its drawing and detailed description are omitted herein for the sake of brevity. Thus, the second rotational speed is decreased to zero and in turn, the first rotational speed is decreased to zero. As a result, the cable drum 20 is stopped from rotating and pulling of the cable 91 is stopped.

In response to the second rotational speed being less than the predetermined speed in operation, the cable drum 20 may rotate freely so that the cable 91 may unwind from the improved self-retracting lifeline device.

The securing frame 10 may be implemented in the following embodiment:

The first flange 14 includes a first hole 141.

The second flange 15 includes an outer vertical plate 151, a horizontal bottom plate 152, and an inner vertical plate 153. The outer vertical plate 151 extends downward from the top plate 12. The horizontal bottom plate 152 interconnects the outer vertical plate 151 and the inner vertical plate 153. The outer vertical plate 151 includes a second hole 15A and a third hole 15B. The inner vertical plate 153 includes a fourth hole 15C and a fifth hole 15D. The first hole 141, the third hole 15B, and the fifth hole 15D are aligned so that the first shaft S1 may be inserted through them to be mounted. This ensures that the first shaft S1 is positioned. The second hole 15A is aligned with the fourth hole 15C so that the second shaft S2 may be inserted through them to be mounted.

The horizontal bottom plate 152 and the inner vertical plate 153 together form an inward bent structure, i.e., U-shaped structure. The second shaft S2 is securely mounted across the second hole 15A and the fourth hole 15C. Thus, the structural strength of the securing frame 10 is greatly increased.

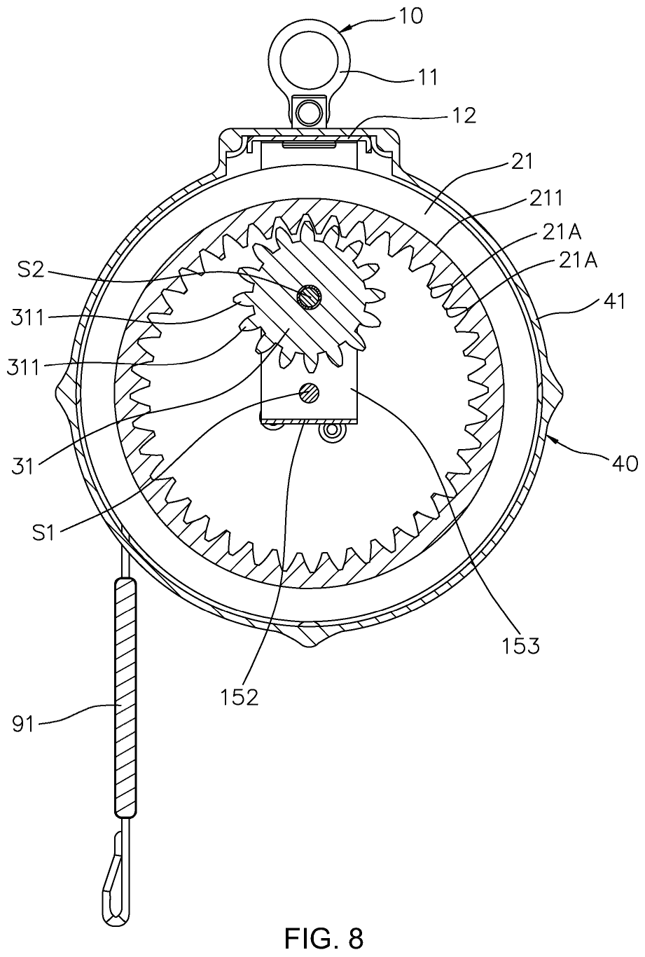

The first gear 211 is formed as a substantially annular protruded portion (see FIG. 8 and FIG. 1) on the first disc 21. It has the advantages of being easy to manufacture and capable of meshing (or gearing) with the second gear 31 properly.

With regard to the cable drum 20 having the cable 91 wound thereon, usually it is provided with a coil spring (not shown) which is well known in the art and thus its drawing and detailed description are omitted herein. The cable 91 may wind to its inoperative position on the cable drum 20 when the pulling force disappears.

The test results of this invention are described as follows.

Length of the cable of the invention and length of the cable of the conventional art is also 6 meters. Test results of the cables under the same condition (such as ANSI Z359.14-2021) are as below.

For the cable of the conventional art, pulling of the cable is stopped after the cable has been further pulled about 45 cm out of the improved self-retracting lifeline device after the improved self-retracting lifeline device has been braked.

For the cable of the invention, pulling of the cable is stopped after the cable has been further pulled about 14 cm out of the improved self-retracting lifeline device after the improved self-retracting lifeline device has been braked.

As such, the braking efficiency of the improved self-retracting lifeline device of the invention increases about 60% in comparison with that of the conventional improved self-retracting lifeline device. It is proved that the invention is more advantageous than the conventional art in terms of being more sensitive in arresting the falling cable when the improved self-retracting lifeline device is braked. That is, the invention is safer.

The invention has the following advantages and benefits in comparison with the conventional art:

First, it is appropriate for a longer cable. The cable is relatively long, the first gear has a plurality of inner teeth, and the first gear meshes the second gear which has the number of outer teeth less than that of the first gear. Thus, the rotational speed of the second gear (i.e., the centrifugal ratchet mechanism) increases, the centrifugal force increases, and the centrifugal ratchet mechanism is easy to activate. This allows to design a product having a longer length of the cable. A moderate centrifugal force is enough to activate the centrifugal ratchet mechanism. Therefore, the invention is appropriate for a longer cable.

It is more sensitive to arrest or the falling cable when the improved self-retracting lifeline device is braked. The rotational speed of the centrifugal ratchet mechanism is increased due to the gearing relationship of the first gear and the second gear. Therefore, the invention is more sensitive to arrest the falling cable when the improved self-retracting lifeline device is braked.

What is claimed is:

1. An improved self-retracting lifeline device, comprising:
a securing frame including a hanging portion, a top plate, a cavity, a first flange, a second flange, a first shaft, and a second shaft wherein the top plate is secured to the hanging portion, the first flange and the second flange are extended downward from two sides of the top plate respectively, the first shaft is disposed across the first flange and the second flange, and the second shaft is disposed through the second flange and above the first shaft;
a cable drum rotatably mounted on the first shaft and disposed between the first flange and the second flange, a cable wound on the cable drum and unwindable therefrom, the cable drum including opposite first and second discs wherein the first disc includes a first gear facing the second flange, the first gear includes a plurality of inner teeth; a rotational speed of the cable drum being defined as a first rotational speed;
a centrifugal ratchet mechanism rotatably mounted on the second shaft, the centrifugal ratchet mechanism including a second gear and a centrifugal ratchet wherein the second gear and the centrifugal ratchet are formed as a unit, the second gear includes a plurality of outer teeth engaged with the inner teeth of the first gear, the centrifugal ratchet includes two opposite ring-shaped surfaces and a plurality of pivoted ratchet portions;
another rotational speed of the centrifugal ratchet mechanism being defined as s a second rotational speed; and
a housing be secured with the securing frame, the housing including a first shell, a second shell, and a space wherein the first shell and the second shell are configured to assemble and the space is formed between the first shell and the second shell; the housing be provided for accommodating the securing frame, the cable drum, and the centrifugal ratchet mechanism;
wherein in response to the second rotational speed being greater than a predetermined speed in operation, a centrifugal force pushes the pivoted ratchet portions outward over the ring-shaped surfaces and at least one of the pivoted ratchet portions inserts into the cavity to be locked therein, thereby decreasing the second rotational speed to zero, decreasing the first rotational speed to zero, stopping the cable drum from rotating, and stopping a pulling of the cable; and
wherein in response to the second rotational speed being less than the predetermined speed in operation, the cable drum is configured to rotate freely and the cable is configured to unwind from the cable drum.

2. The improved self-retracting lifeline device of claim 1, wherein the first flange includes a first hole; and the second flange includes an outer vertical plate, a horizontal bottom plate, and an inner vertical plate wherein the outer vertical plate extends downward from the top plate, the horizontal bottom plate interconnects the outer vertical plate and the inner vertical plate, the outer vertical plate includes a second hole and a third hole, the inner vertical plate includes a fourth hole and a fifth hole, the first hole, the third hole, and the fifth hole are aligned so that the first shaft is configured to insert through the first hole, the third hole, and the fifth hole to be position, and the second hole is aligned with the fourth hole so that the second shaft is configured to insert through the second hole and the fourth hole to be position.

3. The improved self-retracting lifeline device of claim 2, wherein the horizontal bottom plate and the inner vertical plate together form an inward bent structure so that the second shaft is securely mounted across the second hole and the fourth hole.

4. The improved self-retracting lifeline device of claim 1, wherein the first gear is formed as a substantially annular protruded portion on the first disc.
